(19) United States
(12) Patent Application Publication
(10) Pub. No.: US 2016/0155455 A1
(43) Pub. Date: Jun. 2, 2016

(54) A SHARED AUDIO SCENE APPARATUS

(71) Applicant: NOKIA TECHNOLOGIES OY, Espoo (FI)

(72) Inventor: Juha Petteri OJANPERÄ, NOKIA (FI)

(73) Assignee: Nokia Technologies Oy, Espoo (FI)

(21) Appl. No.: 14/891,666

(22) PCT Filed: May 22, 2013
(86) PCT No.: PCT/IB2013/054243

§ 371 Date: Nov. 16, 2015

(51) Int. Cl. G10L 25/51; G10L 25/03; H04R 27/00; H04S 3/00; G10L 25/81; G10L 25/84

(52) U.S. Cl. CPC G10L 25/51; G10L 25/81; G10L 25/84; H04R 27/00; H04S 3/008; G10L 25/03; H04S 2400/15; H04R 2227/003; H04R 2420/07; H04R 2499/11

(57) ABSTRACT

An apparatus comprising: an input configured to select at least two audio signals; a classifier configured to segment the at least two audio signals based on at least two defined class definitions; a class segment analyser configured to determine a difference measure between at least a pair of common class segments from the at least two audio signals using a class based analyser; and a difference analyser configured to determine the at least two audio signal common class segments are within a common event space based on the difference measure.

### FIELD

The present application relates to apparatus for the processing of audio and additionally audio-video signals to enable sharing of audio scene captured audio signals. The invention further relates to, but is not limited to, apparatus for processing audio and additionally audio-video signals to enable sharing of audio scene captured audio signals from mobile devices.

### BACKGROUND

Viewing recorded or streamed audio-video or audio content is well known, Commercial broadcasters covering an event often have more than one recording device (video-camera/microphone) and a programme director will select a ‘mix’ where an output from a recording device or combination of recording devices is selected for transmission.

Multiple ‘feeds’ may be found in sharing services for video and audio signals (such as those employed by YouTube). Such systems, which are known and are widely used to share user generated content recorded and uploaded or upstreamed to a server and then downloaded or down-streamed to a viewing/listening user. Such systems rely on users recording and uploading or upstreaming a recording of an event using the recording facilities at hand to the user. This may typically be in the form of the camera and microphone arrangement of a mobile device such as a mobile phone.

Often the event is attended and recorded from more than one position by different recording users at the same time. The viewing/listening end user may then select one of the up-streamed or uploaded data to view or listen.

### SUMMARY

Aspects of this application thus provide a shared audio capture for audio signals from the same audio scene whereby multiple devices or apparatus can record and combine the audio signals to permit a better audio listening experience.

There is provided according to a first aspect an apparatus comprising at least one processor and at least one memory including computer code for one or more programs, the at least one memory and the computer code configured to with the at least one processor cause the apparatus to at least: select at least two audio signals; segment the at least two audio signals based on at least two defined class definitions; determine a difference measure between at least a pair of common class segments from the at least two audio signals using a class based analyser; and determine the at least two audio signal common class segments are within a common event space based on the difference measure.

The apparatus may be further caused to generate a common time line incorporating the at least two audio signals.

The apparatus may be further caused to align the at least two audio signals when a time difference between two of the at least two audio signals is less than a defined threshold, wherein the time difference is the difference on a common time line incorporating the at least two audio signals for a pair of common class segments from the at least two audio signals.

Segmenting the at least two audio signals based on the at least two classes may cause the apparatus to: analyse the at least two audio signals to determine at least one parameter; and segment the at least two audio signals into parts where the parts of the at least two audio signals are associated with at least one range of values associated with the at least one parameter.

Analysing the at least two audio signals to determine at least one parameter may cause the apparatus to: divide at least one of the audio signals into a number of frames; analyse for at least one frame of the number of frames of the at least one audio signal to determine the at least one parameter value; and determine a class for the at least one frame based on at least one defined range of parameter values.

The at least two classes may comprise at least two of: music; speech; and noise.

Determining a difference measure between at least a pair of common class segments from the at least two audio signals using a class based analyser may cause the apparatus to: allocate a pair of common class segments which overlap to an associated class based analyser; and determine a distance value using the associated class based analyser for the pair of common class segments.

Determining a distance value using the associated class based analyser for the pair of common class segments may further cause the apparatus to determine a binary distance value.

The apparatus may be further caused to determine whether the at least two audio signals are within a common event space based on the determination of the at least two audio signal common class segments are within a common event space.

According to a second aspect there is provided an apparatus comprising: means for selecting at least two audio signals; means for segmenting the at least two audio signals based on at least two defined class definitions; means for determining a difference measure between at least a pair of common class segments from the at least two audio signals using a class based analyser; and means for determining the at least two audio signal common class segments are within a common event space based on the difference measure.

The apparatus may further comprise means for generating a common time line incorporating the at least two audio signals.

The apparatus may further comprise means for aligning the at least two audio signals when a time difference between two of the at least two audio signals is less than a defined threshold, wherein the time difference is the difference on a common time line incorporating the at least two audio signals for a pair of common class segments from the at least two audio signals.

The means for segmenting the at least two audio signals based on the at least two classes may comprise: means for analysing the at least two audio signals to determine at least one parameter; and means for segmenting the at least two audio signals into parts where the parts of the at least two audio signals are associated with at least one range of values associated with the at least one parameter.

The means for analysing the at least two audio signals to determine at least one parameter may comprise: means for dividing at least one of the audio signals into a number of frames; means for analysing for at least one frame of the number of frames of the at least one audio signal to determine the at least one parameter value; and means for determining a class for the at least one frame based on at least one defined range of parameter values.

The at least two classes may comprise at least two of: music; speech; and noise.

The means for determining a difference measure between at least a pair of common class segments from the at least two audio signals using a class based analyser may comprise: means for allocating a pair of common class segments which overlap to an associated class based analyser; and means for determining a distance value using the associated class based analyser for the pair of common class segments.

The means for determining a distance value using the associated class based analyser for the pair of common class segments may comprise means for determining a binary distance value.

The apparatus may further comprise means for determining whether the at least two audio signals are within a common event space based on the determination of the at least two audio signal common class segments are within a common event space.

According to a third aspect there is provided a method comprising: selecting at least two audio signals; segmenting the at least two audio signals based on at least two defined class definitions; determining a difference measure between at least a pair of common class segments from the at least two audio signals using a class based analyser; and determining the at least two audio signal common class segments are within a common event space based on the difference measure.

The method may further comprise generating a common time line incorporating the at least two audio signals.

The method may further comprise aligning the at least two audio signals when a time difference between two of the at least two audio signals is less than a defined threshold, wherein the time difference is the difference on a common time line incorporating the at least two audio signals for a pair of common class segments from the at least two audio signals.

Segmenting the at least two audio signals based on the at least two classes may comprise: analysing the at least two audio signals to determine at least one parameter; and segmenting the at least two audio signals into parts where the parts of the at least two audio signals are associated with at least one range of values associated with the at least one parameter.

Analysing the at least two audio signals to determine at least one parameter may comprise: dividing at least one of the audio signals into a number of frames; analysing for at least one frame of the number of frames of the at least one audio signal to determine the at least one parameter value; and determining a class for the at least one frame based on at least one defined range of parameter values.

The at least two classes may comprise at least two of: music; speech; and noise.

Determining a difference measure between at least a pair of common class segments from the at least two audio signals using a class based analyser may comprise: allocating a pair of common class segments which overlap to an associated class based analyser; and determining a distance value using the associated class based analyser for the pair of common class segments.

Determining a distance value using the associated class based analyser for the pair of common class segments may comprise determining a binary distance value.

The method may further comprise determining whether the at least two audio signals are within a common event space based on the determination of the at least two audio signal common class segments are within a common event space.

According to a fourth aspect there is provided an apparatus comprising: an input configured to select at least two audio signals; a classifier configured to segment the at least two audio signals based on at least two defined class definitions; a class segment analyser configured to determine a difference measure between at least a pair of common class segments from the at least two audio signals using a class based analyser; and a difference analyser configured to determine the at least two audio signal common class segments are within a common event space based on the difference measure.

The apparatus may further comprise a segment smoother configured to generate a common time line incorporating the at least two audio signals.

The segment smoother may be configured to align the at least two audio signals when a time difference between two of the at least two audio signals is less than a defined threshold, wherein the time difference is the difference on a common time line incorporating the at least two audio signals for a pair of common class segments from the at least two audio signals.

The classifier may be configured to: analyse the at least two audio signals to determine at least one parameter; and segment the at least two audio signals into parts where the parts of the at least two audio signals are associated with at least one range of values associated with the at least one parameter.

The classifier may comprise: a framer configured to divide at least one of the audio signals into a number of frames; an analyser configured to analyse for at least one frame of the number of frames of the at least one audio signal to determine the at least one parameter value; and a frame classifier configured to determine a class for the at least one frame based on at least one defined range of parameter values.

The at least two classes may comprise at least two of: music; speech; and noise.

The class segment analyser may be configured to: allocate a pair of common class segments which overlap to an associated class based analyser; and determine a distance value using the associated class based analyser for the pair of common class segments.

The class segment analyser may be configured to determine a binary distance value.

The apparatus may further comprise an event space assigner configured to determine whether the at least two audio signals are within a common event space based on the determination of the at least two audio signal common class segments are within a common event space.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For better understanding of the present application, reference will now be made by way of example to the accompanying drawings in which:

FIG. 1 shows schematically a multi-user free-viewpoint service sharing system which may encompass embodiments of the application;

FIG. 2 shows schematically an apparatus suitable for being employed in embodiments of the application;

FIG. 3 shows schematically an example content co-ordinating apparatus according to some embodiments;

FIG. 4 shows a flow diagram of the operation of the example content co-ordinating apparatus shown in FIG. 3 according to some embodiments;

FIG. 5 shows an example audio segment; and

FIGS. 6 to 9 show audio alignment examples according to some embodiments.

### EMBODIMENTS OF THE APPLICATION

The following describes in further detail suitable apparatus and possible mechanism for the provision of effective audio signal capture sharing. In the following examples, audio signals and audio capture signals are described. However it would be appreciated that in some embodiments the audio signal/audio capture is a part of an audio-video system.

The concept of this application is related to assisting in the production of immersive person-to-person communication and can include video. It would be understood that the space within which the devices record the audio signal can be arbitrarily positioned within an event space. The captured signals as described herein are transmitted or alternatively stored for later consumption where the end user can select the listening point based on their preference from the reconstructed audio space. The rendering part then can provide one or more down mixed signals from which the multiple recordings that correspond to the selective listening point. It would be understood that each recording device can record the event seen and upload or upstream the recorded content. The uploaded or upstream process can include implicitly positioning information about where the content is being recorded.

Furthermore an audio scene can be defined as a region or area within which a device or recording apparatus effectively captures the same audio signal. Recording apparatus operating within an audio scene and forwarding the captured or recorded audio signals or content to a co-ordinating or management apparatus effectively transmit many copies of the same or very similar audio signal. The redundancy of many devices capturing the same audio signal permits the effective sharing of the audio recording or capture operation.

Content or audio signal discontinuities can occur, especially when the recorded content is uploaded to the content server after some time the recording has taken place that the uploaded content represents an edited version rather than the actual recorded content. For example the user can edit any recorded content before uploading the content to the content server. The editing can for example involve removing unwanted segments from the original recording. The signal discontinuity can create significant challenges to the content server as typically an implicit assumption is made that the uploaded content represents the audio signal or clip from a continuous timeline. Where segments are removed (or added) after recording has ended then the continuity assumption or condition no longer holds for the particular content.

Furthermore to be able to jointly utilize the multi-user recorded content for various media rendering methods, such as audio mixing from multiple users and video view switching from one user to the other, the content between different users must employ a ‘common’ time or timeline. Furthermore, the common timeline should be constructed such that the content from different devices or apparatus shares the same event space. For example users and their apparatus or devices may move in and out of a defined audio event space during recording or capturing resulting in a situation where there may be time periods when some apparatus do not share the same event space even though they share the same timeline. Furthermore depending on the event venue there may exist multiple event spaces that are not correlated. For example an event venue with different rooms and/or floors can result in multiple event spaces from the content capturing and rendering point of view.

The concept as described herein in embodiments is to analyse and segment the recorded or captured content from an event venue into different event spaces. This invention outlines method for creating event spaces from multi-user captured content. The concept can further be summarized according to the following steps:
Classifying recorded or captured media content to generate media segments associated with a defined class
Applying analysis to media segments based the associated class
Determining similarities between segments of different user/apparatus media
Creating event spaces based on similarity status for different user/apparatus media

In some embodiments the classification comprises at least 2 classes, for example a music class and a non-music class. Furthermore in some embodiments the classes can furthermore be sub-divided into subclasses of which the sub-classes are grouped, for example the music class can be divided into a music-classical, and music-rock sub-classes.

In some embodiments the media analysis is applied to each class present in the segment from different user media.

In some embodiments the audio domain properties are used to provide event space separation resulting fast and computationally efficient operation.

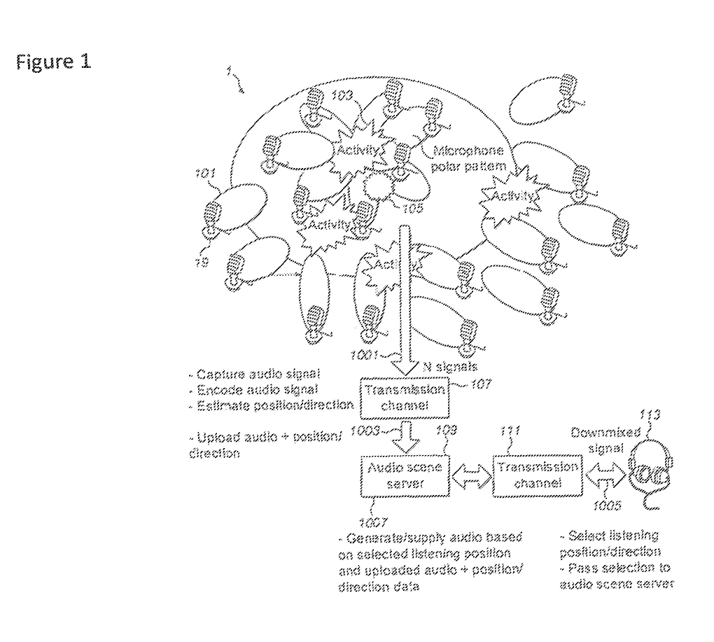

With respect to FIG. 1 an overview of a suitable system within which embodiments of the application can be located is shown. The audio space 1 can have located within it at least one recording or capturing device or apparatus 19 which are arbitrarily positioned within the audio space to record suitable audio scenes. The apparatus 19 shown in FIG. 1 are represented as microphones with a polar gain pattern 101 showing the directional audio capture gain associated with each apparatus. The apparatus 19 in FIG. 1 are shown such that some of the apparatus are capable of attempting to capture the audio scene or activity 103 within the audio space. The activity 103 can be any event the user of the apparatus wishes to capture. For example the event could be a music event or audio of a “news worthy” event. The apparatus 19 although being shown having a directional microphone gain pattern 101 would be appreciated that in some embodiments the microphone or microphone array of the recording apparatus 19 has a omnidirectional gain or different gain profile to that shown in FIG. 1.

Each recording apparatus 19 can in some embodiments transmit or alternatively store for later consumption the captured audio signals via a transmission channel 107 to an audio scene server 109. The recording apparatus 19 in some embodiments can encode the audio signal to compress the audio signal in a known way in order to reduce the bandwidth required in “uploading” the audio signal to the audio scene server 109.

The recording apparatus 19 in some embodiments can be configured to estimate and upload via the transmission channel 107 to the audio scene server 109 an estimation of the location and/or the orientation or direction of the apparatus. The position information can be obtained, for example, using GPS coordinates, cell-ID or a-GPS or any other suitable location estimation methods and the orientation/direction can be obtained, for example using a digital compass, accelerometer, or gyroscope information.

In some embodiments the recording apparatus 19 can be configured to capture or record one or more audio signals for example the apparatus in some embodiments have multiple microphones each configured to capture the audio signal from different directions. In such embodiments the recording device or apparatus 19 can record and provide more than one signal from different the direction/orientations and further supply position/direction information for each signal, With respect to the application described herein an audio or sound source can be defined as each of the captured or audio recorded signal. In some embodiments each audio source can be defined as having a position or location which can be an absolute or relative value. For example in some embodiments the audio source can be defined as having a position relative to a desired listening location or position. Furthermore in some embodiments the audio source can be defined as having an orientation, for example where the audio source is a beamformed processed combination of multiple microphones in the recording apparatus, or a directional microphone. In some embodiments the orientation may have both a directionality and a range, for example defining the 3 dB gain range of a directional microphone.

The capturing and encoding of the audio signal and the estimation of the position/direction of the apparatus is shown in FIG. 1 by step 1001.

The uploading of the audio and position/direction estimate to the audio scene server 109 is shown in FIG. 1 by step 1003.

The audio scene server 109 furthermore can in some embodiments communicate via a further transmission channel 111 to a listening device 113.

In some embodiments the listening device 113, which is represented in FIG. 1 by a set of headphones, can prior to or during downloading via the further transmission channel 111 select a listening point, in other words select a position such as indicated in FIG. 1 by the selected listening point 105. In such embodiments the listening device 113 can communicate via the further transmission channel 111 to the audio scene server 109 the request.

The selection of a listening position by the listening device 113 is shown in FIG. 1 by step 1005.

The audio scene server 109 can as discussed above in some embodiments receive from each of the recording apparatus 19 an approximation or estimation of the location and/or direction of the recording apparatus 19. The audio scene server 109 can in some embodiments from the various captured audio signals from recording apparatus 19 produce a composite audio signal representing the desired listening position and the composite audio signal can be passed via the further transmission channel 111 to the listening device 113.

The generation or supply of a suitable audio signal based on the selected listening position indicator is shown in FIG. 1 by step 1007.

In some embodiments the listening device 113 can request a multiple channel audio signal or a mono-channel audio signal. This request can in some embodiments be received by the audio scene server 109 which can generate the requested multiple channel data.

The audio scene server 109 in some embodiments can receive each uploaded audio signal and can keep track of the positions and the associated direction/orientation associated with each audio source. In some embodiments the audio scene server 109 can provide a high level coordinate system which corresponds to locations where the uploaded/upstreamed content source is available to the listening device 113. The “high level” coordinates can be provided for example as a map to the listening device 113 for selection of the listening position. The listening device (end user or an application used by the end user) can in such embodiments be responsible for determining or selecting the listening position and sending this information to the audio scene server 109. The audio scene server 109 can in some embodiments receive the selection/determination and transmit the downmixed signal corresponding to the specified location to the listening device. In some embodiments the listening device/end user can be configured to select or determine other aspects of the desired audio signal, for example signal quality, number of channels of audio desired, etc. In some embodiments the audio scene server 109 can provide in some embodiments a selected set of downmixed signals which correspond to listening points neighbouring the desired location/direction and the listening device 113 selects the audio signal desired.

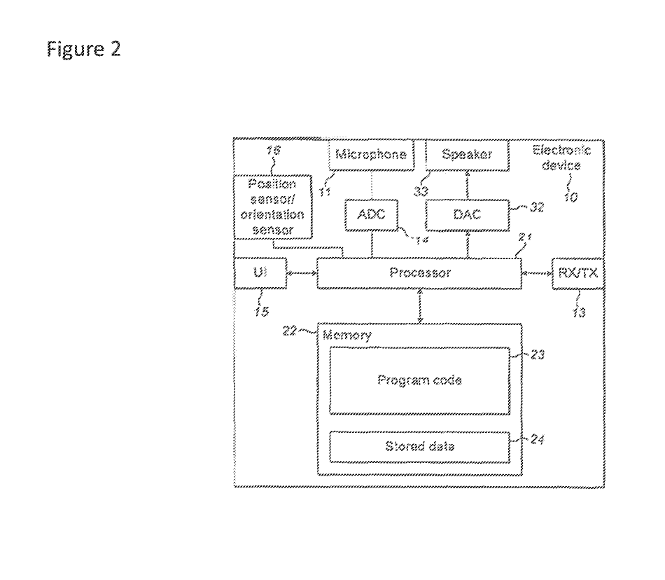

In this regard reference is first made to FIG. 2 which shows a schematic block diagram of an exemplary apparatus or electronic device 10, which may be used to record (or operate as a recording or capturing apparatus 19) or listen (or operate as a listening apparatus 113) to the audio signals (and similarly to record or view the audio-visual images and data), Furthermore in some embodiments the apparatus or electronic device can function as the audio scene server 109.

The electronic device 10 may for example be a mobile terminal or user equipment of a wireless communication system when functioning as the recording device or listening device 113. In some embodiments the apparatus can be an audio player or audio recorder, such as an MP3 player, a media recorder/player (also known as an MP4 player), or any suitable portable device suitable for recording audio or audio/video camcorder/memory audio or video recorder.

The apparatus 10 can in some embodiments comprise an audio subsystem. The audio subsystem for example can comprise in some embodiments a microphone or array of microphones 11 for audio signal capture. In some embodiments the microphone or array of microphones can be a solid state microphone, in other words capable of capturing audio signals and outputting a suitable digital format signal. In some other embodiments the microphone or array of microphones 11 can comprise any suitable microphone or audio capture means, for example a condenser microphone, capacitor microphone, electrostatic microphone, electret condenser microphone, dynamic microphone, ribbon microphone, carbon microphone, piezoelectric microphone, or microelectrical-mechanical system (MEMS) microphone. The microphone 11 or array of microphones can in some embodiments output the audio captured signal to an analogue-to-digital converter (ADC) 14.

In some embodiments the apparatus can further comprise an analogue-to-digital converter (ADC) 14 configured to receive the analogue captured audio signal from the microphones and outputting the audio captured signal in a suitable digital form. The analogue-to-digital converter 14 can be any suitable analogue-to-digital conversion or processing means.

In some embodiments the apparatus 10 audio subsystem further comprises a digital-to-analogue converter 32 for converting digital audio signals from a processor 21 to a suitable analogue format. The digital-to-analogue converter (DAC) or signal processing means 32 can in some embodiments be any suitable DAC technology.

Furthermore the audio subsystem can comprise in some embodiments a speaker 33. The speaker 33 can in some embodiments receive the output from the digital-to-analogue converter 32 and present the analogue audio signal to the user. In some embodiments the speaker 33 can be representative of a headset, for example a set of headphones, or cordless headphones.

Although the apparatus 10 is shown having both audio capture and audio presentation components, it would be understood that in some embodiments the apparatus 10 can comprise one or the other of the audio capture and audio presentation parts of the audio subsystem such that in some embodiments of the apparatus the microphone (for audio capture) or the speaker (for audio presentation) are present.

In some embodiments the apparatus 10 comprises a processor 21. The processor 21 is coupled to the audio subsystem and specifically in some examples the analogue-to-digital converter 14 for receiving digital signals representing audio signals from the microphone 11, and the digital-to-analogue converter (DAC) 12 configured to output processed digital audio signals. The processor 21 can be configured to execute various program codes. The implemented program codes can comprise for example audio signal or content shot detection routines.

In some embodiments the apparatus further comprises a memory 22. In some embodiments the processor is coupled to memory 22. The memory can be any suitable storage means. In some embodiments the memory 22 comprises a program code section 23 for storing program codes implementable upon the processor 21. Furthermore in some embodiments the memory 22 can further comprise a stored data section 24 for storing data, for example data that has been analysed and classified in accordance with the application or data to be analysed or classified via the application embodiments as described later. The implemented program code stored within the program code section 23, and the data stored within the stored data section 24 can be retrieved by the processor 21 whenever needed via the memory-processor coupling.

In some further embodiments the apparatus 10 can comprise a user interface 15. The user interface 15 can be coupled in some embodiments to the processor 21. In some embodiments the processor can control the operation of the user interface and receive inputs from the user interface 15. In some embodiments the user interface 15 can enable a user to input commands to the electronic device or apparatus 10, for example via a keypad, and/or to obtain information from the apparatus 10, for example via a display which is part of the user interface 15. The user interface 15 can in some embodiments comprise a touch screen or touch interface capable of both enabling information to be entered to the apparatus 10 and further displaying information to the user of the apparatus 10.

In some embodiments the apparatus further comprises a transceiver 13, the transceiver in such embodiments can be coupled to the processor and configured to enable a communication with other apparatus or electronic devices, for example via a wireless communications network. The transceiver 13 or any suitable transceiver or transmitter and/or receiver means can in some embodiments be configured to communicate with other electronic devices or apparatus via a wire or wired coupling.

The coupling can, as shown in FIG. 1, be the transmission channel 107 (where the apparatus is functioning as the recording device 19 or audio scene server 109) or further transmission channel 111 (where the device is functioning as the listening device 113 or audio scene server 109). The transceiver 13 can communicate with further devices by any suitable known communications protocol, for example in some embodiments the transceiver 13 or transceiver means can use a suitable universal mobile telecommunications system (UMTS) protocol, a wireless local area network (WLAN) protocol such as for example IEEE 802.X, a suitable short-range radio frequency communication protocol such as Bluetooth, or infrared data communication pathway (IRDA).

In some embodiments the apparatus comprises a position sensor 16 configured to estimate the position of the apparatus 10. The position sensor 16 can in some embodiments be a satellite positioning sensor such as a GPS (Global Positioning System), GLONASS or Galileo receiver.

In some embodiments the positioning sensor can be a cellular ID system or an assisted GPS system.

In some embodiments the apparatus 10 further comprises a direction or orientation sensor. The orientation/direction sensor can in some embodiments be an electronic compass, accelerometer, a gyroscope or be determined by the motion of the apparatus using the positioning estimate.

It is to be understood again that the structure of the electronic device 10 could be supplemented and varied in many ways.

Furthermore it could be understood that the above apparatus 10 in some embodiments can be operated as an audio scene server 109. In some further embodiments the audio scene server 109 can comprise a processor, memory and transceiver combination.

In the following examples there are described an audio scene/content recording or capturing apparatus which correspond to the recording device 19 and an audio scene/content co-ordinating or management apparatus which corresponds to the audio scene server 109. However it would be understood that in some embodiments the audio scene management apparatus can be located within the recording or capture apparatus as described herein and similarly the audio scene recording or content capture apparatus can be a part of an audio scene server 109 capturing audio signals either locally or via a wireless microphone coupling.

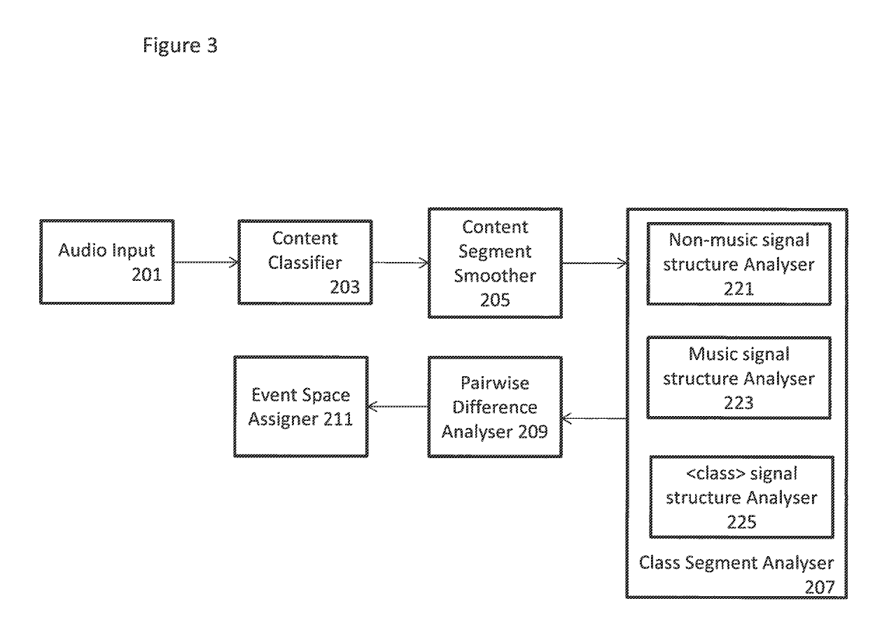

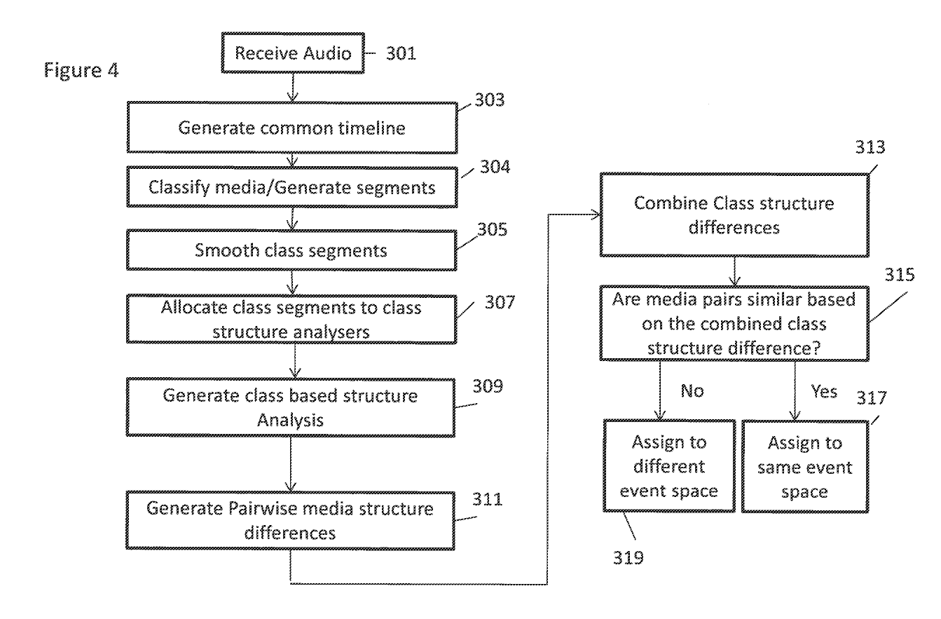

With respect to FIG. 3 an example content co-ordinating apparatus according to some embodiments is shown which can be implemented within the recording device 19, the audio scene server, or the listening device (when acting as a content aggregator). Furthermore FIG. 4 shows a flow diagram of the operation of the example content co-ordinating apparatus shown in FIG. 3 according to some embodiments.

In some embodiments the content coordinating apparatus comprises an audio input 201. The audio input 201 can in some embodiments be the microphone input, or a received input via the transceiver or other wire or wireless coupling to the apparatus. In some embodiments the audio input 201 is the memory 22 and in particular the stored data memory 24 where any edited or unedited audio signal is stored.

The operation of receiving the audio input is shown in FIG. 4 by step 301.

In some embodiments the content coordinating apparatus comprises a content classifier 203. The content classifier 203 can in some embodiments receive the audio input signal and be configured (where the input signal is not originally) to align the input audio signal according to its initial time stamp value. In the following example the input audio signal has a start timestamp T=x and length or end time stamp T=y, in other words the input audio signal is defined by the pair wise value of (x, y).

In some embodiments the initial time stamp based alignment can be performed with respect to one or more reference audio content parts. In some embodiments the input audio signal is aligned against a reference audio content time stamp where both the input audio signal and reference audio signal are known to use a common clock time stamp. For example in some embodiments the recording of the audio signal can be performed with an initial time stamp provided the apparatus internal clock or a received clock signal, such as a cellular clock time stamp, a positioning or GPS clock time stamp or any other received clock signal.

The operation of initially aligning the input audio signal against a reference signal or generating a common timeline is shown in FIG. 4 by step 303.

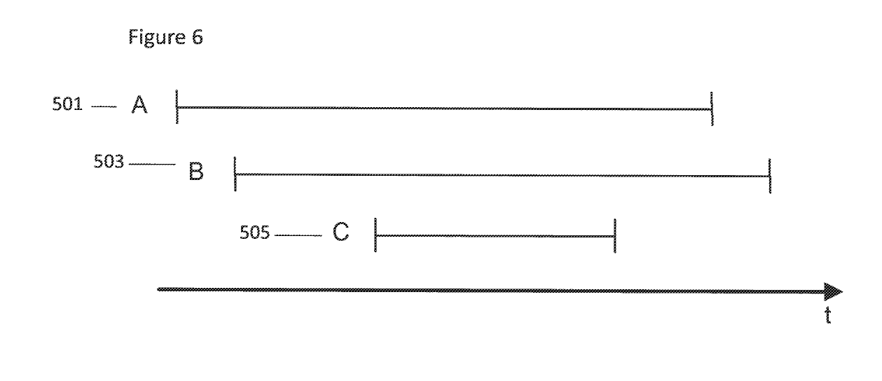

With respect to FIG. 6 an example audio signal or media set is shown. In this example there are three audio signals or media signals. A first audio or media signal A 501, a second audio or media signal B 503 and a third audio or media signal C 505. In this example the three example audio signals A 501, B 503 and C 505 are received and aligned relative to each other. In the example shown in FIG. 6 the audio signals are ordered such that the audio signal A 501 is the first audio signal ‘received’ or the first to start, the audio signal B 503 is the second audio signal ‘received’ or the second to start, and the audio signal C 505 is the third audio signal received or the third to start. Furthermore in the audio signals are ordered such that the audio signal A 501 is the second audio signal to finish, the audio signal B 503 is the third to finish, and the audio signal C 505 is the first to finish with the overall length of the audio signal being audio signal B 503 being longest, the audio signal C 505 the shortest and audio signal A 501 being slightly shorter than audio signal B 503.

Furthermore in some embodiments the content classifier 203 is configured to analyse the audio signal and determine a classification of the audio signal segment.

In some embodiments the content classifier 203 is configured to analyse the input audio signals and segment the audio signal according to a determined or associated class. For example in some embodiments the content classifier 203 can be configured analyse the received audio (or media) signal and assign parts or segments to classes such as a ‘music’ or ‘non-music’ class.

It would be understood that in some embodiments there can be more than two classes or sub-classes. For example in some embodiments there can be sub-classes within each class. For example in some embodiments the content classifier 203 can be configured to determine a ‘classical music’ segment or assign or associate a ‘classical music’ sub-class to an audio segment and a ‘rock music’ segment or assign or associate a ‘rock music’ sub-class to a different segment. For example the audio signal captured or recorded by the same apparatus can change class as the apparatus moves from a first room playing classical music to a second room playing rock music.

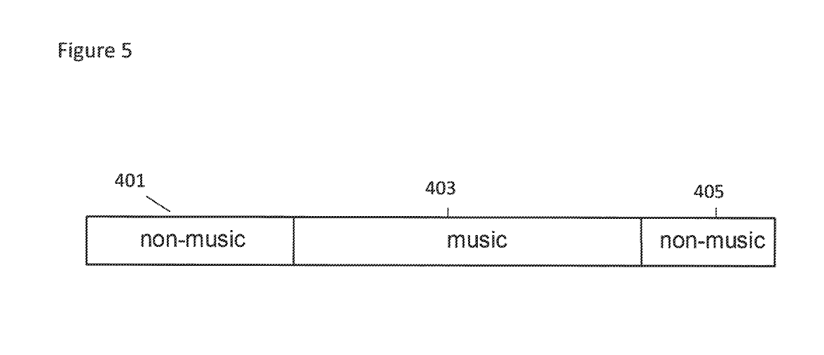

For example FIG. 5 shows a representation of a captured or recorded audio signal or media which is analysed by the content classifier 203, and segmented into three parts based on the determined audio signal class. In this example the captured or recorded audio signal comprises a first part or segment 401 which is determined as being or associated with a non-music class, a second part or segment 403 which is determined as being or associated with a music class, and a third part or segment 405 which is determined as being or associated with a non-music class.

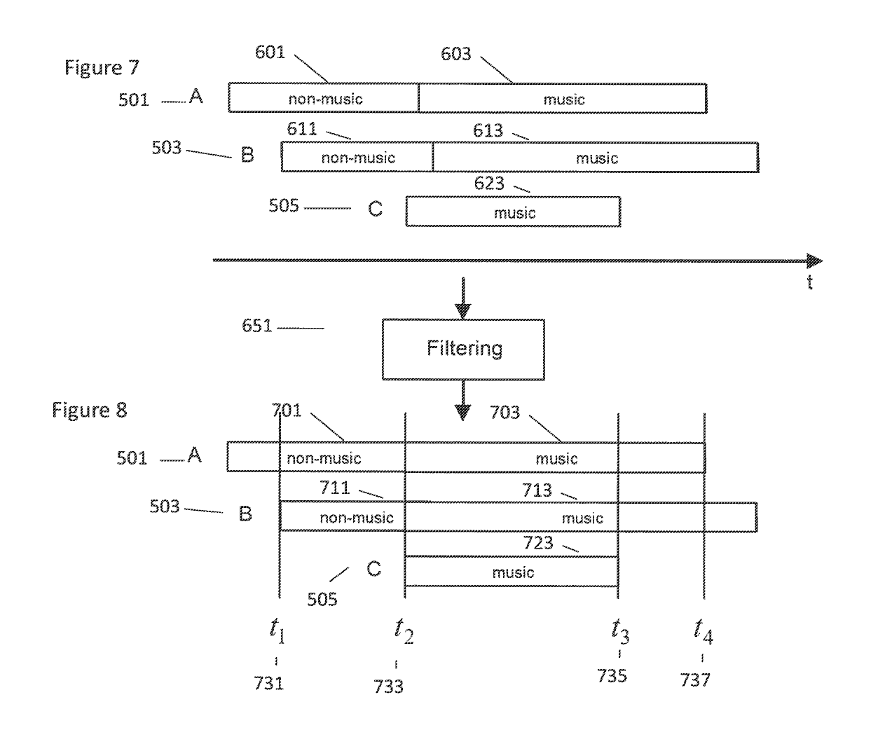

Furthermore with respect to FIG. 7 the segmentation of the example audio signal or media set shown in FIG. 5 is shown. In this example the first audio or media signal A 501 comprises a first non-music segment 601 followed by a music segment 603. The second audio or media signal B 503 comprises a first non-music segment 611 followed by a music segment 613, The third audio or media signal C 505 comprises a music segment 623.

In the example shown in FIG. 7 the segmentation of the example audio signal or media set is such that the boundary between the non-music segments 601, 611 from the first audio signal A 501 and the second audio signal B 503 and the music segments 603, 613, 623 from the first audio signal A 501, the second audio signal B 503 and the third audio signal C 505 respectively are not aligned.

The operation of classifying media or generating segments with associated classes is shown in FIG. 4 by step 304.

In some embodiments the audio input can be pre-classified, in other words the audio signal is received with metadata with associated classification values associated with the audio signal and defining audio signal segments.

In some embodiments the content classifier 203 can be configured to output the classified content or captured audio to a content segment smoother 205.

In some embodiments the content classifier 203 can be configured to receive the audio signal and generate frames or sub-frames time divided parts of the audio signal. For example in some embodiments the content classifier 203 can be configured to generate a frame of 20 ms where each frame comprises a sub-frame which overlaps by 10 ms with the preceding frame and a second sub-frame which overlaps by 10 ms with the succeeding frame.

Furthermore in some embodiments the content classifier 203 is configured to analyse the audio signal on a frame by frame (or sub-frame by sub-frame) basis, and for each frame (or sub-frame) determine at least one possible feature or parameter value. In such embodiments each classification or class or sub-class can have an assigned or associated feature value range against which the determined feature or parameter value or feature (or parameter) values can then be compared to determine a classification or class for the frame (or sub-frame).

For example the feature values for a frame can in some embodiments be located within a space or vector map within which are determined classification boundaries defining audio classifications and from which can be determined a classification for each frame.

For example a classifier which can be used in some embodiments is the one described in “Features for Audio and Music Classification” by McKinney and Breebaart, Proc. 4th Int. Conf. on Music Information Retrieval, which is configured to determine classifications such as Classical Music, Jazz, Folk, Electronica, R&B, Rock, Reggae, Vocal, Speech, Noise, and Crowd Noise.

The analysis features can in some embodiments be any suitable features such as spectral features such as cepstral coefficients, frequency warping, magnitude warping, Mel-frequency cepstral coefficients, spectral centroid, bandwidth, temporal features such as rise time, onset asynchrony at different frequencies, frequency modulation (amplitude and rate), amplitude modulation (amplitude and rate), zero crossing rate, short-time energy values, etc.

In some embodiments the features are selected for analysis according to any suitable manner, for example data normalisation, Sequential backward selection (SBS), principal component analysis, Eigenanalysis (determining the eigenvectors and eigenvalues of the data set), or feature transformation (linear or otherwise) can be used.

The classifier can in some embodiments generate classification from the feature values according to any suitable manner, such as for example by a supervised (or taught) classifier or unsupervised classifier. The classifier can for example in some embodiments be configured to use a minimum distance classification method. In some embodiments the classifier be configured to use a k-nearest neighbour (k-NN) classifier where the k nearest neighbours are picked to the feature value x and then choose the class which was most often picked. In some embodiments the classifier employs statistical classification techniques where the feature vector value is interpreted as a random variable whose distribution depends on the class (for example by applying Baysian, Gausian mixture models, or maximum a posteriori MAP, Hidden Markov model HMM, methods).

The exact set of classes or classifications can in some embodiments vary depending on the audio signals being analysed and the environment within which the audio signals were recorded or are being analysed. For example in some embodiments there can be a user interface input selecting the set of classes, or the set of classes can be chosen by an automatic or semi-automatic means.

In some embodiments the content coordinating apparatus comprises a content segment smoother 205. The content segment smoother 205 can be configured to receive the audio signal or media content which has been analysed and segmented by the content classifier 203 and filter audio signals. The purpose of this filtering is to adjust the class segment boundaries such that small differences in the start and end boundaries between different audio signals media are removed.

For example with respect to the example segmentation as shown in FIG. 6 the content segment smoother 205 filtering is shown as action 651, the results of which are shown in FIG. 8.

With respect to FIG. 8 the segmentation of the example audio signal or media set shown in FIGS. 5 and 6 is shown having been filtered to attempt to align any small difference between audio signal segments with the same class. For example using the first audio or media signal A 501 as a reference signal with a segment boundary between the non-music segment 701 and the music segment 703 at time instant t₂ 733 and with the music segment ends at time instant t₄ 737. The content segment smoother 205 can then in some embodiments be configured to filter or shift the second audio or media signal B 503 such that the non-music segment 711 starts at time t₁ 731 so that the non-music segment 711 ends at time t₂ 733 (in other words aligns the end of the second audio signal B 503 non-music segment 711 to the first audio signal A 501 non-music segment).

This shift furthermore aligns the second audio signal B 503 music segment 713 to the first audio signal A 501 music segment 703.

The content segment smoother 205 can then in some embodiments be configured to filter or shift the third audio or media signal C 505 such that the music segment 723 starts at time t₂ 733 in other words aligns the start of the third audio signal C 505 music segment 723 to the first audio signal A 501 music segment 703. This shift furthermore aligns the second audio signal B 503 music segment 713 to the third audio signal C 505 music segment 723. The shift of the third audio signal means that the third audio signal C 505 music segment ends at time t₃ 735, which occurs before t₄ 737.

The content segment smoother 205 can then, in some embodiments, output the ‘filtered’ or aligned signals to a class segment analyser 207.

The smoothing or filtering of the class segments is shown in FIG. 4 by step 305.

In some embodiments the content coordinating apparatus comprises a class segment analyser 207. The class segment analyser 207 can be configured to receive the segmented and smoothed audio signals or media content. The class segment analyser 207 can in some embodiments comprise a class based signal structure analyser for the determined classes. Thus for example as shown in FIG. 3 the class segment analyser 207 comprises a non-music signal structure analyser 221 and a music signal structure analyser 223. Furthermore the generic class signal structure analyser is represented within FIG. 3 by the <class> structure analyser 225.

In some embodiments the class segment analyser 207 is configured to allocate class segments to their associated class signal structure analysers. Thus for example with respect to the audio signals shown in FIG. 8 the class segment analyser 207 is configured to allocate the audio signal A 501 non-music segment 701 to the non-music signal structure analyser 221, and the music segment 703 to the music segment analyser 223. Furthermore the class segment analyser 207 is configured to allocate the audio signal B 503 non-music segment 711 to the non-music signal structure analyser 221, and the music segment 713 to the music segment analyser 223. With respect to the audio signal C 505 the music segment 723 is allocated by the class segment analyser 207 to the music segment analyser 223.

The operation of allocating class segment to class structure analysers is shown in FIG. 4 by step 307.

In some embodiments the class signal structure analysers are then configured to analyse the allocated audio or media segments for any overlapping audio segments. In other words the class signal structure analysers are configured to analyse pairs of audio signals where there are at least two audio signals with the same segment class at the same time. The number of analyses to be applied for a media segment depends on the amount of different classes within the overlapping class segment. For example, if only music segments are present within the overlapping class segment, then music based analysis is applied for each media segment. However, if the overlapping class segment contains 2 or more different classes (that is, one media segment may get assigned to ‘music’ whereas the some other media segment may get assigned to ‘non-music’), then the same number of analyses are applied to each media segment regardless whether a particular class was assigned initially to the media segment or not. The class signal structure analysis results can then be passed to the pairwise difference analyser 209.

Thus for example with respect to the audio signals shown in FIG. 8 the timeline comprises 3 overlapping class segments. These overlapping class segments are the time period from t₁-t₂, t₂-t₃, and t₃-t₄. The first overlapping class segment from t₁-t₂ comprises part of audio signal A 501 non-music segment 701 and audio signal B 503 non-music segment 711 and is analysed by the non-music signal structure analyser 221. The non-music signal structure analyser 221 can be configured to analyse these of audio signals and pass the results to the pairwise difference analyser 209.

The second overlapping class segment from t₂-t₃ comprises part of audio signal A 501 music segment 703, part of audio signal B 503 music segment 713 and audio signal C 505 music segment 723 and is analysed by the music signal structure analyser 223. The music signal structure analyser 223 can be configured to analyse these of audio signals and pass the results to the pairwise difference analyser 209.

The third overlapping class segment from t₃-t₄ comprises a latter part of audio signal A 501 music segment 703, and a latter part of audio signal B 503 music segment 713 and is analysed by the music signal structure analyser 223. The music signal structure analyser 223 can be configured to analyse these of audio signals and pass the results to the pairwise difference analyser 209.

In some embodiments the signal structure analysers, such as the non-music signal structure analyser 221 and the music structure analyser 223 are is configured to analyse the audio signal segments on a frame by frame (or sub-frame by sub-frame) basis, and for each frame (or sub-frame) determine at least one possible class based feature or parameter value. In such embodiments the class based at least one feature or parameter has values which can then be compared to determine differences within the pairwise difference analyser 209.

In some embodiments the class based at least one feature or parameter value for a frame can be the same values which were used by the content classifier to define the classes. For example a classifier which can be used in some embodiments is the one described in “Features for Audio and Music Classification” by McKinney and Breebaart. Proc. 4th Int. Conf. on Music Information Retrieval, which is configured to determine classifications such as Classical Music, Jazz, Folk, Electronics, R&B, Rock, Reggae, Vocal, Speech, Noise, and Crowd Noise.

The analysis features can in some embodiments be any suitable features such as spectral features such as cepstral coefficients, frequency warping, magnitude warping, Mel-frequency cepstral coefficients, spectral centroid, bandwidth, temporal features such as rise time, onset asynchrony at different frequencies, frequency modulation (amplitude and rate), amplitude modulation (amplitude and rate), zero crossing rate, short-time energy values, etc.

It would be understood that in some embodiments a first class signal structure analyser can be configured to generate or determine a first set of features or parameters while a second class signal structure analyser can be configured to generate or determine a second set of features or parameters. In some embodiments the first set of features overlaps at least partially the second set of features.

For example for the ‘music’ class the music class dependent analysis can comprise any suitable music structure analysis techniques. For example, in some embodiments the bars (or beats) of a music segment are determined and compared.

In some embodiments the signal structure analysers are configured to filter the feature or parameter values determined by the content classifier 203 and pass the filtered feature or parameter values to the pairwise difference analyser 209.

The operation of generating class based structure analysis is shown in FIG. 4 by step 309.

In some embodiments the content coordinating apparatus comprises a pairwise difference analyser 209.

The pairwise difference analyser 209 can be configured in some embodiments to receive the signal structure analysis results and pairwise analyse these to determine differences which are passed to an event space assigner 211. In some embodiments the pairwise difference analyser 209 is configure to perform a decision based on the difference to determine whether the pairwise selection is similar or not. In other words the pairwise difference analyser can be configured to compare on an audio signal or media segment pairwise manner to determine whether the signal structure analysis results are similar enough (indicating same event space) or not (indicating different event space).

The operation of generating pairwise media structure difference is shown in FIG. 4 by step 311.

In some embodiments the comparison is applied with respect to the other audio signals or media segments within the same overlapping class segment.

In other words the class structure differences in some embodiments can be combined.

The operation of combining class structure differences is shown in FIG. 4 by step 313.

The analysis comparison can in some embodiments be configured to return a binary decision value 0 or 1 which can be then summed across all applied analyses classes.

For example with respect to the music segments and where the feature value is bar or beat times where the difference in bar or beat times is too great (for example in the order of a second or more), the media in the pair are not similar and a binary decision of similarity of 0 is generated, and where the difference is less than the determined value (for example one second) then a binary decision of similarity of 1 is generated.

The content coordinating apparatus can in some embodiments comprise an event space assigner 211. The event space assigner 211 can be configured to receive the output of the pairwise difference analyser (for example the similarity binary decision or the difference values combined) and then determine whether the media pairs or audio signals are similar enough to be assigned to the same event space or not.

In some embodiments the event space assigner can therefore assign the same event space to the pair of audio signals by analysing the binary decision. In some embodiments the same event space determination can be made from the difference values output by the pairwise difference analyser.

Thus for example the event space assigner 211 can be configured to determine whether the media pairs are similar based on the combined class structure difference.

The operation of determining whether the media pairs are similar based on the combined class structure difference is shown in FIG. 4 by step 315.

Where the media pairs are similar based on the combined class structure difference then the event space assigner 211 can be configured to assign both to the same event space.

The operation of assigning both of the audio signals (media pair) to the same event space is shown in FIG. 4 by step 317.

Where the media pairs are not similar based on the combined class structure difference then the event space assigner 211 can be configured to assign the audio signals or media to different event spaces.

The operation of assigning the audio signals (media) to difference event spaces is shown in FIG. 4 by step 319.

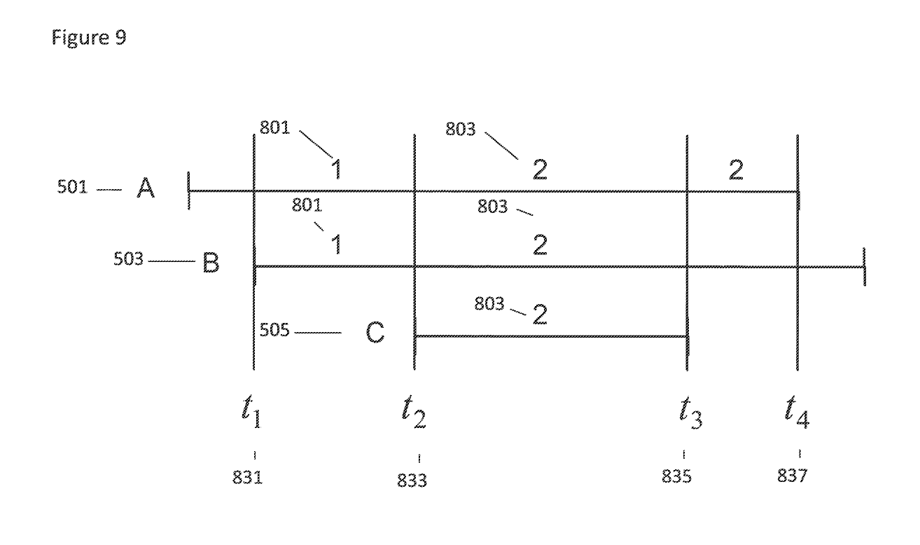

With respect to FIG. 9 the example audio signals as shown in FIGS. 6 to 8 are shown having been assigned. The event space assignment for each overlapping class segment operates such that one of the media in the pair has already been assigned to at least one event space and the other media is assigned at this stage. For example the audio signals A 501, B 503, and C 505 for some arbitrary overlapping class segment, the event space assignment can be as follows:

The audio signal pairs are: A-B (for the first overlap period from t₁-t₂), A-C (for the second overlap period from t₂-t₃), and BTC (for the second overlap period from t₁-t₂), and A-B (for the third overlap period from t₃-t₄)

In some embodiments the event space assigner can be configured to assign for the audio signal A 501 non-music segment 701 event space 1 801.

The first audio signal pairing is A-B (for the first overlap period from t₁-t₂) where A non-music segment 701 is part of event space 1

Audio signal B non-music segment 711 therefore is assigned to event space 1 if the audio signals are similar or otherwise assigned to event space 2 (which would be a new event space). In the example as shown in FIG. 9 the Audio signal B non-music segment 711 is similar and therefore is assigned to event space 1.

In some embodiments the event space assigner can be configured to assign for the audio signal A 501 music segment 703 event space 2 803.

The second audio signal or media pair is A-C (for the second overlap period from t₂-t₃) where audio signal A 501 music segment 703 is part of event space 2 803. Audio signal or Media C therefore assigned to event space 2 where they are similar or otherwise to event space 3 (a new event space). In the example as shown in FIG. 9 the Audio signal C music segment 723 is similar and therefore is assigned to event space 2.

The third audio signal or media pair is B-C (for the second overlap period from t₂-t₃) where audio signal C 505 music segment 723 is part of event space 2 803 (it would be understood that a similar pairing can be A-B which would lead to a similar result).

Audio signal or Media B is therefore assigned to event space 2 where they are similar or otherwise to event space 3 (a new event space). In the example as shown in FIG. 9 the Audio signal B music segment 713 is similar and therefore is assigned to event space 2.

A fourth audio signal or media pair is A-B (for the third overlap period from t₃-t₄) where audio signal A 501 music segment 703 is part of event space 2 803,

Audio signal or Media B is therefore assigned to event space 2 for the third overlap period where they are similar or otherwise to event space 3 (a new event space), In the example as shown in FIG. 9 the Audio signal B music segment 713 for the third overlap period is similar and therefore is assigned to event space 2.

After all overlapping class segments have been processed, each media has been assigned to at least one event space.

In some embodiments the audio signal may get over-segmented, that is, it is assigned to too many event spaces. This may occur especially for example where the classification is not able to detect classes correctly (for example, it is not able to decide whether media segment belongs to ‘music’ or ‘non-music’ and class segment alternates as a function of time). In some embodiments in order to reduce the risk of assigning too many event spaces to one media then event spaces for an audio signal or media are filtered such that a higher priority is given to event spaces with longer duration.

For example, an event space with a short duration (less than 10 sec) is between longer duration event spaces (longer than 20 sec), then the short duration event space is discarded and assigned to the longer duration event space.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings.

Although the above has been described with regards to audio signals, or audio-visual signals it would be appreciated that embodiments may also be applied to audio-video signals where the audio signal components of the recorded data are processed in terms of the determining of the base signal and the determination of the time alignment factors for the remaining signals and the video signal components may be synchronised using the above embodiments of the invention. In other words the video parts may be synchronised using the audio synchronisation information.

It shall be appreciated that the term user equipment is intended to cover any suitable type of wireless user equipment, such as mobile telephones, portable data processing devices or portable web browsers.

Furthermore elements of a public land mobile network (PLMN) may also comprise apparatus as described above.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1-21. (canceled)

22. Apparatus comprising at least one processor and at least one memory including computer code for one or more programs, the at least one memory and the computer code configured to with the at least one processor cause the apparatus to at least:
select at least two audio signals;
segment the at least two audio signals based on at least two defined classes;
determine a difference measure between at least a pair of segments of the at least two audio signals, wherein a first segment of the at least pair of segments is a segment of a first of the at least two audio signals, wherein a second segment of the at least pair of segments is a segment of a second of the least two audio signal, and wherein the first segment of the at least pair of segments has a same class of the at least two defined classes as the second segment of the at least pair of segments; and
determine that the at least pair of segments of the at least two audio signals are within a common event space based on the difference measure.

23. The apparatus as claimed in claim 22, further caused to generate a common time line incorporating the at least two audio signals.

24. The apparatus as claimed in claim 23, further caused to align the at least two audio signals when a time difference between two of the at least two audio signals is less than a defined threshold, wherein the time difference is the difference on the common time line incorporating the at least two audio signals for the at least pair of segments of the at least two audio signals.

25. The apparatus as claimed in claim 22, wherein the apparatus caused to segment the at least two audio signals based on the at least two defined classes is caused to:
analyse the at least two audio signals to determine at least one parameter; and
segment the at least two audio signals into parts where the parts of the at least two audio signals are associated with at least one range of values associated with the at least one parameter.

26. The apparatus as claimed in claim 25, wherein the apparatus caused to analyse the at least two audio signals to determine at least one parameter is caused to:
divide at least one of the at least two audio signals into a number of frames;
analyse for at least one frame of the number of frames of the at least one audio signal to determine the at least one parameter value; and
determine a class for the at least one frame based on at least one defined range of parameter values.

27. The apparatus as claimed in claim 22, wherein the at least two defined classes comprise at least two of:
music;
speech; and
noise.

28. The apparatus as claimed in claim 22, wherein the apparatus caused to determine a difference measure between the at least pair of segments of the at least two audio signals is caused to:
allocate the at least pair of segments of the at least two audio signals to an associated class based analyser, wherein the first segment of the at least pair of segments and the second segment of the at least pair of segments overlap in time; and
determine a distance value using the associated class based analyser for the allocated at least pair of segments of the at least two audio signals.

29. The apparatus as claimed in claim 28, wherein the apparatus caused to determine the distance value using the associated class based analyser for the at least pair of segments of the at least two audio signals is further caused to determine a binary distance value.

30. A method comprising:
selecting at least two audio signals;
segmenting the at least two audio signals based on at least two defined classes;
determining a difference measure between at least a pair of segments of the at least two audio signals, wherein a first segment of the at least pair of segments is a segment of a first of the at least two audio signals, wherein a second segment of the at least pair of segments is a segment of a second of the least two audio signal, and wherein the first segment of the at least pair of segments has a same class of the at least two defined classes as the second segment of the at least pair of segments; and
determining that the at least pair of segments of the at least two audio signals are within a common event space based on the difference measure.

31. The method as claimed in claim 30, further comprising generating a common time line incorporating the at least two audio signals.

32. The method as claimed in claim 31, further comprising aligning the at least two audio signals when a time difference between two of the at least two audio signals is less than a defined threshold, wherein the time difference is the difference on the common time line incorporating the at least two audio signals for the at least pair of segments of the at least two audio signals.

33. The method as claimed in claim 30, wherein segmenting the at least two audio signals based on the at least two defined classes comprises:
analysing the at least two audio signals to determine at least one parameter; and
segmenting the at least two audio signals into parts where the parts of the at least two audio signals are associated with at least one range of values associated with the at least one parameter.

34. The method as claimed in claim 33, wherein analysing the at least two audio signals to determine at least one parameter comprises:
dividing at least one of the at least two audio signals into a number of frames;
analysing for at least one frame of the number of frames of the at least one audio signal to determine the at least one parameter value; and
determining a class for the at least one frame based on at least one defined range of parameter values.

35. The method as claimed in claim 30, wherein the at least two defined classes comprise at least two of:
music;
speech; and
noise.

36. The method as claimed in claim 30, wherein determining a difference measure between the at least pair of segments of the at least two audio signals comprises:
allocating the at least pair of segments of the at least two audio signals to an associated class based analyser, wherein the first of the at least pair of segments and the second of the at least pair of segments overlap in time; and
determining a distance value using the associated class based analyser for the allocated at least pair of segments of the at least two audio signals.

37. The method as claimed in claim 36, wherein determining the distance value using the associated class based analyser for the at least pair of segments of the at least two audio signals further comprises determining a binary distance value.

38. A computer program product comprising a non-transitory computer-readable medium bearing computer program code embodied therein, the computer program code configured to cause an apparatus at least to perform:
selecting at least two audio signals;
segmenting the at least two audio signals based on at least two defined classes;
determining a difference measure between at least a pair of segments of the at least two audio signals, wherein a first segment of the at least pair of segments is a segment of a first of the at least two audio signals, wherein a second segment of the at least pair of segments is a segment of a second of the least two audio signal, and wherein the first segment of the at least pair of segments has a same class of the at least two defined classes as the second segment of the at least pair of segments; and
determining that the at least pair of segments of the at least two audio signals are within a common event space based on the difference measure.

39. The computer program product as claimed in claim 38 further configured to cause the apparatus at least to perform generating a common time line incorporating the at least two audio signals.

40. The computer program product as claimed in claim 39 further configured to cause the apparatus at least to perform aligning the at least two audio signals when a time difference between two of the at least two audio signals is less than a defined threshold, wherein the time difference is the difference on the common time line incorporating the at least two audio signals for the at least pair of segments of the at least two audio signals.

41. The computer program product as claimed in claim 38, wherein the computer program product configured to cause an apparatus at least to perform segmenting the at least two audio signals based on the at least two defined classes is configured to cause the apparatus at least to perform:
analysing the at least two audio signals to determine at least one parameter; and
segmenting the at least two audio signals into parts where the parts of the at least two audio signals are associated with at least one range of values associated with the at least one parameter.
